(19) United States
(12) Patent Application Publication
(10) Pub. No.: US 2020/0098026 A1
(43) Pub. Date: Mar. 26, 2020

(54) METHOD AND SYSTEM FOR THIRD PARTY PURCHASES

(71) Applicant: Keren HUMMEL ALON, Ramat Yishav (IL)

(72) Inventor: Keren HUMMEL ALON, Ramat Yishav (IL)

(21) Appl. No.: 16/611,541

(22) PCT Filed: May 8, 2018
(86) PCT No.: PCT/IL2018/050500

§ 371 Date: Nov. 7, 2019

Related U.S. Application Data
(60) Provisional application No. 62/502,787, filed on May 8, 2017.

(51) Int. Cl. G06Q 30/06; G06F 16/2455; G06F 16/23; G06Q 20/12; G06Q 20/08

(52) U.S. Cl. CPC G06Q 30/0617; G06F 16/2455; G06Q 20/0855; G06Q 20/12; G06Q 30/0635; G06F 16/2379

(57) ABSTRACT

Methods and systems provide for payments for items, e.g., goods and services, selected by others to be made by the authorized holder of a payment card, e.g., a third party to the transaction, for whom the items are intended. As a result, a valid and authorized payment card purchase is made, for example, directly, between the actual credit card holder and the seller, so as to be within the rules of the payment card (payment card issuer).

### CROSS REFERENCES TO RELATED APPLICATIONS

This application is related to and claims priority from commonly owned U.S. Provisional Patent Application Ser. No. 62/502,787, entitled: Purchasing Goods With 3^{rd} Party Payments, filed on May 8, 2017, the disclosure of which is incorporated by reference in its entirety herein.

### TECHNICAL FIELD

The present invention is directed to methods and systems for making payments.

### BACKGROUND

Today's economy is heavily dependent on credit cards and debit cards, collectively known as “payment cards.” For example, the authorized payment card holder may give their payment card to another person to make purchases for them. Purchase transactions made in this manner, are technically invalid under the rules of the payment card. Accordingly, the seller should not accept the payment card, as it is not presented to him by the actual payment card holder.

Also, the relationship between the payment card holder and the person with his payment card making the purchase from the seller is based on trust alone. The person making the purchase can purchase other items or services not authorized by the payment card holder. Here, the payment card holder lacks protection and recourse against the payment card companies for these unauthorized items or services purchased by the person with their payment card.

Even assuming that the person making the purchase with the aforementioned payment card of another may do so, the seller may have to call or otherwise contact the payment card holder, which takes time. If the payment card holder cannot be contacted, or fails to respond within a certain time, the sale is lost.

Additionally, many people, even those with credit cards, may not want their identity known or the item or service, or point of sale, listed on receipts and monthly payment card statements, known. These people would also like to use a third party payer. Finally, there are people without payment cards who need to make a credit card payment, for example, when the seller is remote and/or the seller only accepts payment cards.

### SUMMARY OF THE INVENTION

The present invention provides methods and systems which allow payments for items, e.g., goods and services, selected by others to be made by the authorized holder of a payment card, e.g., a third party to the transaction, for whom the items are intended. As a result, a valid and authorized payment card purchase is made, for example, directly, between the actual credit card holder and the seller, so as to be within the rules of the payment card (payment card issuer). Additionally, the payer can see exactly what items and services have been selected for purchase by the payer, and the payer can decide the specific items or goods which have been selected, which he will pay for. Additionally, as the aforementioned system and method are computerized, the selection of items and services, followed by the payment thereof by the payer, and release of the items and/or services to the party who selected the items, e.g., goods and/or services, which are now accessible to the party who selected the items, can be done in real time.

Embodiments of the invention are directed to a computerized method for making payments for items selected by a buyer, for example, who is not the payer. The method comprises: receiving, by a main computer over a communications network, 1) an electronic data object including a listing of one or more items, each of the one or more items of the electronic data object selected by a buyer associated with a buyer computer, from a supplier associated with a supplier computer; and, 2) a selection of a payer for the items of the electronic data object, from the buyer computer; the main computer responding to receipt of the electronic data object and the selection of a payer by transmitting a copy of the electronic data object to a computer associated with the payer, the copy of the electronic data object mapped to the computer of each supplier for each of the items and to the main computer; and, the main computer receiving a payment indication, over the communications network, from each of the supplier computers for the items which the payer has paid for, the payment indication additionally being an indicator that all items that were paid for are released to the buyer.

Optionally, the method additionally comprises: for the items that were not paid for, creating a subsequent electronic data object including the items that were not paid for, and presenting the subsequent data object to the buyer computer to receive a selection for a payer for the electronic data object.

Optionally, the method additionally comprises: the main computer responding to receipt of the subsequent electronic data object and the selection of a payer by transmitting a copy of the subsequent electronic data object to a computer associated with the payer, the copy of the electronic data object mapped to the computer of each supplier for each of the items and to the main computer.

Optionally, the method additionally comprises: the main computer receiving a payment indication, over the communications network, from each of the supplier computers for the items which the payer has paid for, the payment indication additionally being an indicator that all items that were paid for are released to the buyer.

Optionally, the receiving the selection of a payer includes receiving a selection of at least one of: a specific payer, or a request for the main computer to select the payer.

Optionally, the specific payer includes a payer from a database of payers associated with the buyer, or a payer not from a database of payers associated with the buyer.

Optionally, the request for the main computer to select a payer is based on rules and policies.

Optionally, prior to the initial receipt of the electronic data object, the electronic data object includes a listing of one or more items is presented to the buyer via the buyer computer, and the buyer, via the buyer computer, is prompted to select a payer for the items of the electronic data object.

Optionally, the method additionally comprises, the main computer receiving an acceptance indication for the items of the electronic data object which the payer will pay for, transmitted to the main computer from the payer computer.

Optionally, the method additionally comprises, the main computer receiving an acceptance indication for the items of the electronic data object which the payer will pay for in accordance with rules and policies.

Optionally, the method is such that if an acceptance indication is not received for an item and/or the payer has failed to pay for an item within a predetermined time, the first computer takes at least one action including: 1) creating a subsequent electronic data object including the unaccepted item and/or the not paid for item, and sending the subsequent electronic data object to the buyer computer for selection of a payer; 2) terminating the electronic data object; or, 3) storing the electronic data object.

Optionally, the method is such that, if the at least one action includes creating a subsequent electronic data object including the unaccepted item and/or the not paid for item, and sending the subsequent electronic data object to the buyer computer for selection of a payer, the main computer:
(a) receives from the buyer computer, over the communications network, 1) the subsequent electronic data object including a listing of the unaccepted and/or not paid for item; and, 2) a selection of a payer for the items of the electronic data object;
(b) responds to receipt of the electronic data object and the selection of the payer by transmitting a copy of the electronic data object to the computer associated with the payer, the copy of the electronic data object mapped to the computer of each supplier for each of the items and to the main computer; and,
(c) receives a payment indication over the communications network, from each of the supplier computers for the items which the payer has paid for, the payment indicator additionally being an indicator that all items which were paid for are released to the buyer, and accessible to the buyer.

Optionally, the electronic data object includes at least one electronic shopping cart.

Optionally, the subsequent electronic data object includes at least one electronic shopping cart.

Optionally, the electronic data object is from a web site or an application.

Embodiments of the invention are directed to a method for paying for items purchased by a buyer, for example, who is not the payer. The method comprises: receiving, by a payment system associated with a main computer, a first electronic data object including items associated from at least one supplier and a selection of a payer for the items of the first electronic data object, from a computer associated with a buyer of the items of the first electronic data object; sending, by the payment system associated with the main computer, a second electronic data object, based on the first electronic data object, to a computer associated with the selected payer for the first electronic data object, the second electronic data object mapped to the computer associated with the at least one supplier and the main computer; receiving acceptance indications whether each item of the second electronic data object that was accepted by the payer for payment, and, for items that were accepted by the payer for payment and paid for, receiving a payment indication; for items of the second electronic data object that were either not accepted for payment by the payer and/or not paid for by the payer, the payment system of the main computer creating a third electronic data object for the non accepted items and/or the unpaid items for presentation to the buyer via the computer associated with the buyer; and, for items of the second electronic data object that were accepted and paid for by the payer, for which the payment indication was received by the payment system of the main computer, the payment indication additionally indicating that the paid for items of the second electronic data object are accessible to the buyer.

Optionally, the payment system of the main computer receives the acceptance indications and the payment indications.

Optionally, the payment indications are received from the computer associated with the supplier of each paid for item.

Optionally, each item of the second electronic data object that was accepted by the payer for payment, becomes an unpaid item if not paid for by the payer within a predetermined time.

Optionally, the payment system associated with the main computer transmits the third electronic data object to the computer associated with the buyer and causes the computer associated with the buyer to prompt the buyer to select a payer for the third electronic data object and the items thereof.

Optionally, the payment system associated with the main computer performs at least one process including: transmitting the third electronic data object to computer associated with the selected payer; storing the third electronic data object; or, terminating the third electronic data object.

Optionally, the second electronic data object is a copy of the first electronic data object.

Optionally, the third electronic data object is created with items from the second electronic data object.

Optionally, the third electronic data object includes some of the items of the second electronic data object.

Optionally, the third electronic data object includes all of the items of the second electronic data object.

Optionally, the third electronic data object is the second electronic data object.

Optionally, the first electronic data object, the second electronic data object, and the third electronic data object are electronic shopping carts.

Optionally, the first electronic data object, the second electronic data object, and the third electronic data object are from a web page or an application.

Embodiments of the invention are also directed to a computer system for paying for items purchased by a buyer, e.g., who is not the payer. The system comprises: a storage medium for storing computer components; and, at least one processor for executing the computer components. The computer components comprise: a first computer component for receiving a first electronic data object including items associated from at least one supplier, and a selection of a payer for the items of the first electronic data object, from a computer associated with a buyer of the items of the first electronic data object; a second computer component for sending a second electronic data object, based on the first electronic data object, to a computer associated with the selected payer for the first electronic data object, the second electronic data object mapped to the computer associated with the at least one supplier and the main computer; a third computer component for receiving acceptance indications whether each item of the second electronic data object that was accepted by the payer for payment, and, for items that were accepted by the payer for payment and paid for, receiving a payment indication; and, a fourth computer component for: creating a third electronic data object for the non accepted items and/or the unpaid items of the second electronic data object, for presentation to the buyer via the computer associated with the buyer; and, receiving at least one payment indication for items of the second electronic data object that were accepted and paid for by the payer, the at least one payment indication additionally indicating that the paid for items of the second electronic data object are accessible to the buyer.

Optionally, the second electronic data object is a copy of the first electronic data object.

Optionally, the third electronic data object is created with items from the second electronic data object.

Optionally, the third electronic data object includes some of the items of the second electronic data object.

Optionally, the third electronic data object includes all of the items of the second electronic data object.

Optionally, the third electronic data object is the second electronic data object.

Optionally, the first electronic data object, the second electronic data object, and the third electronic data object are electronic shopping carts.

Embodiments of the invention are directed to a computer usable non-transitory storage medium having a computer program embodied thereon for causing a suitable programmed system to pay for items purchased by a buyer, by performing the following steps when such program is executed on the system. The steps comprise: receiving a first electronic data object including items associated from at least one supplier and a selection of a payer for the items of the first electronic data object, from a computer associated with a buyer of the items of the first electronic data object; sending a second electronic data object, based on the first electronic data object, to a computer associated with the selected payer for the first electronic data object, the second electronic data object mapped to the computer associated with the at least one supplier and the main computer; receiving acceptance indications whether each item of the second electronic data object that was accepted by the payer for payment, and, for items that were accepted by the payer for payment and paid for, receiving a payment indication; for items of the second electronic data object that were either not accepted for payment by the payer and/or not paid for by the payer, creating a third electronic data object for the non accepted items and/or the unpaid items for presentation to the buyer via the computer associated with the buyer; and, for items of the second electronic data object that were accepted and paid for by the payer, for which the payment indication was received, the payment indication additionally indicating that the paid for items of the second electronic data object are accessible to the buyer.

Optionally, the computer usable non-transitory storage medium is such that the steps additionally comprise: receiving the acceptance indications and the payment indications.

Optionally, the computer usable non-transitory storage medium is such that the payment indications are received from the computer associated with the supplier of each paid for item.

Optionally, the computer usable non-transitory storage medium is such that, each item of the second electronic data object that was accepted by the payer for payment, becomes an unpaid item if not paid for by the payer within a predetermined time.

Optionally, the computer usable non-transitory storage medium is such that, the payment system associated with the main computer transmits the third electronic data object to the computer associated with the buyer and causes the computer associated with the buyer to prompt the buyer to select a payer for the third electronic data object and the items thereof.

Optionally, the computer usable non-transitory storage medium is such that, the steps additionally comprise performing at least one process including: transmitting the third electronic data object to computer associated with the selected payer; storing the third electronic data object; or, terminating the third electronic data object.

Optionally, the computer usable non-transitory storage medium is such that, the second electronic data object is a copy of the first electronic data object.

Optionally, the computer usable non-transitory storage medium is such that, the third electronic data object is created with items from the second electronic data object.

Optionally, the computer usable non-transitory storage medium is such that, the third electronic data object includes some of the items of the second electronic data object.

Optionally, the computer usable non-transitory storage medium is such that, the third electronic data object includes all of the items of the second electronic data object.

Optionally, the computer usable non-transitory storage medium is such that, the third electronic data object is the second electronic data object.

Optionally, the computer usable non-transitory storage medium is such that, the first electronic data object, the second electronic data object, and the third electronic data object are electronic shopping carts.

This document references terms that are used consistently or interchangeably herein. These terms, including variations thereof, are as follows.
Throughout this document, a “web site” is a related collection of World Wide Web (WWW) files that includes a beginning file or “web page” called a home page, and typically, additional files or “web pages.” The term “web site” is used collectively to include “web site” and “web page(s).”

A uniform resource locator (URL) is the unique address for a file, such as a web site or a web page, that is accessible over Networks including the Internet.
“n” and “n^{th}” in the description below and the drawing figures represents the last member of a series or sequence of members, such as elements, computers, servers, databases, caches, components, listings, links, data files, etc.

A “computer” includes machines, computers and computing or computer systems (for example, physically separate locations or devices), servers, computer and computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile devices that can be readily transported from one location to another location (e.g., smart phone, personal digital assistant (PDA), mobile telephone or cellular telephone).

A “server” is typically a remote computer or remote computer system, or computer program therein, in accordance with the “computer” defined above, that is accessible over a communications medium, such as a communications network or other computer network, including the Internet. A “server” provides services to, or performs functions for, other computer programs (and their users), in the same or other computers. A server may also include a virtual machine, a software based emulation of a computer.

An “application”, includes executable software, and optionally, any graphical user interfaces (GUI), through which certain functionalities may be implemented.

A “client” is an application that runs on a computer, workstation or the like and relies on a server to perform some of its operations or functionality.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a diagram of an exemplary environment for the system in which embodiments of the disclosed subject matter are performed;

FIG. 2A is a block diagram of the architecture of the home server of FIG. 1 and the system thereof;

FIG. 2B is a diagram of the Payer Database of FIG. 2A;

FIG. 3 is a flow diagram of an example process in accordance with embodiments of the present invention for a single cart from a single supplier;

FIG. 4 is a flow diagram of an example process in accordance with embodiments of the present invention for a single cart from multiple suppliers;

FIG. 5 is a flow diagram of an example process in accordance with embodiments of the present invention for multiple carts for each of the corresponding multiple suppliers;

FIGS. 6A-6H are screen diagrams of displays that appear on the computer or computer monitors of computers associated with the processes of the embodiments of the invention of the flow diagram of FIG. 3; and,

FIGS. 7A-7K are screen diagrams of displays that appear on the computer or computer monitors of computers associated with the processes of the embodiments of the invention of the flow diagram of FIG. 4.

### DETAILED DESCRIPTION OF THE DRAWINGS

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more non-transitory computer readable (storage) medium(s) having computer readable program code embodied thereon.

Throughout this document, numerous textual and graphical references are made to trademarks. These trademarks are the property of their respective owners, and are referenced only for explanation purposes herein.

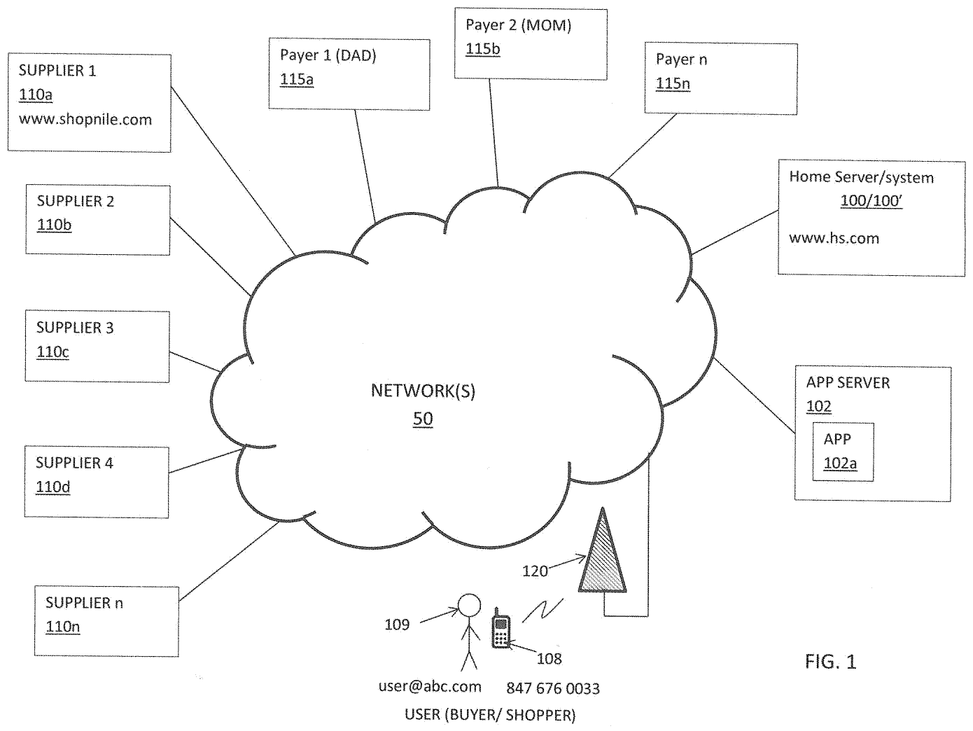

Reference is now made to FIG. 1, which shows an exemplary operating environment, including a network(s) 50 (hereinafter “network”), to which is linked a home server (HS) 100, also known as a home computer, a main server or main computer, these terms used interchangeably herein. The home server 100 also supports a system 100′, either alone or with other, computers, including servers, components, and applications, e.g., client applications, associated with either the home server 100, as detailed below. The network 50 is, for example, a communications network, such as a Local Area Network (LAN), or a Wide Area Network (WAN), including public networks such as the Internet. As shown in FIG. 1, the network 50 is, for example, the Internet. The network 50, although shown as a single network, may be a combination of networks and/or multiple networks including, for example, in addition to the Internet, one or more cellular networks, wide area networks (WAN), and the like. “Linked” as used herein includes both wired or wireless links, either direct or indirect, and placing the computers, including, servers, components and the like, in electronic and/or data communications with each other.

The home server 100 and the system 100′ perform the various processes in accordance with the present invention, as detailed below. The home server 100 is such that it receives data objects, e.g., electronic carts, copies electronic carts, augments electronic carts, or creates new electronic carts, handles the electronic carts within the system 100′, transmits the electronic carts over the network 50 to the various entities 108, 110a-110n, 115a-115n linked to the network 50. The system 100′ also and creates mappings for the aforementioned electronic carts between one or more of the various entities using the system 100′, including, the home server/system 100/100′ itself, the suppliers, represented by computers 110a-110n, payers, represented by computers 115a-115n and buyers 109, represented by computer 108, at various times.

The home server (HS) 100 is of an architecture that includes one or more components, engines, modules and the like, for providing numerous additional server functions and operations. The home server (HS) 100 may be associated with additional storage, memory, caches and databases, both internal and external thereto. For explanation purposes, the home server (HS) 100 may have a uniform resource locator (URL) of, for example, www.hs.com. While a single home server (HS) 100 is shown, the home server (HS) 100 may be formed of multiple servers and/or components.

An Application Server 102 includes one or more applications (APPs) 102a. From the application server 102, suppliers, e.g., Supplier 1 to Supplier n, via their computers, for example, servers 110a-110n, and users (buyers/shoppers) 108 (via computer 109, represented by a smartphone), can access, e.g., by download, their respective applications 102a to use the system 100′.

The application (APP) 102a includes code segments which map to the system 100′ of the home server 100, for allowing supplier computer 110a-110n and user computer 108 interaction with the system 100′. There are also code segments, including self-executing instructions, for performing functions such as setting up the electronic carts (electronic data objects), also referred to herein as “carts”, adding/subtracting items from the electronic cart, providing the electronic cart with a list of payers for the cart (e.g., in the form of a menu), sending the cart to the system 100′, and linking the cart to various entities, e.g., suppliers 110a-110n, and payers (computers 115a-115n).

These computers 110a-110n of Supplier 1 to Supplier n are linked to the network 50, and are representative of computers associated with numerous suppliers of products and services. For example, for explanation purposes, Supplier 1 110a is a large on-line retailer (with the URL www.shopnile.com) who sells multiple items, e.g., products and services, from multiple suppliers and bundles the items selected by a user (buyer/shopper) 108 into a single electronic cart, also referred to as an electronic data object, on its website, where the user 108 shops by selecting web site displayed items. Also, for example, for explanation purposes, Suppliers 2, 3 and 4 110b, 110c, 110d, sell specialty items and use an electronic data object or cart of the APP 102a.

Computers 115a, 115b (these element numbers are also used to represent the payer associated therewith), for example, mobile devices, laptop computers, tablet computers, e.g., iPads® from Apple® of Cupertino, Calif., USA, and servers, link to the network(s) 50. The computers 115a, 115b are associated with Payers, e.g., Payer 1 115a and Payer 2, 115b of the system 100′, who are representative of all payers for the system (through the payer associated with the computer 115n).

While the servers 100, 102, 110a-110n and 115a-115n which are shown in FIG. 1 and described herein, are those most germane to the disclosure of the invention herein, other servers computers and the like, linked to the network 50, either directly or indirectly, are also permitted.

The user computer 108, shown as a smart phone, links to the network via a cellular tower 120, WiFi® or the like. The user computer 108 is associated with the telephone number 847-676-0033 and the email user@abc.com. While the user computer 108 is shown as a smart phone or mobile computer, the user computer 108 can be a standard desktop computer, workstation or the like, laptop, tablet (e.g., iPad® from Apple). The user computer 108, for example, runs web browsing applications (for accessing web sites and web pages and URLs), such as Chrome®, Internet Explorer®, FireFox®, Edge®, and may use voice activated browsing application such as Siri™. The user computer 108 may also be a voice operated device such as Amazon® Echo™, as linked to the network 50.

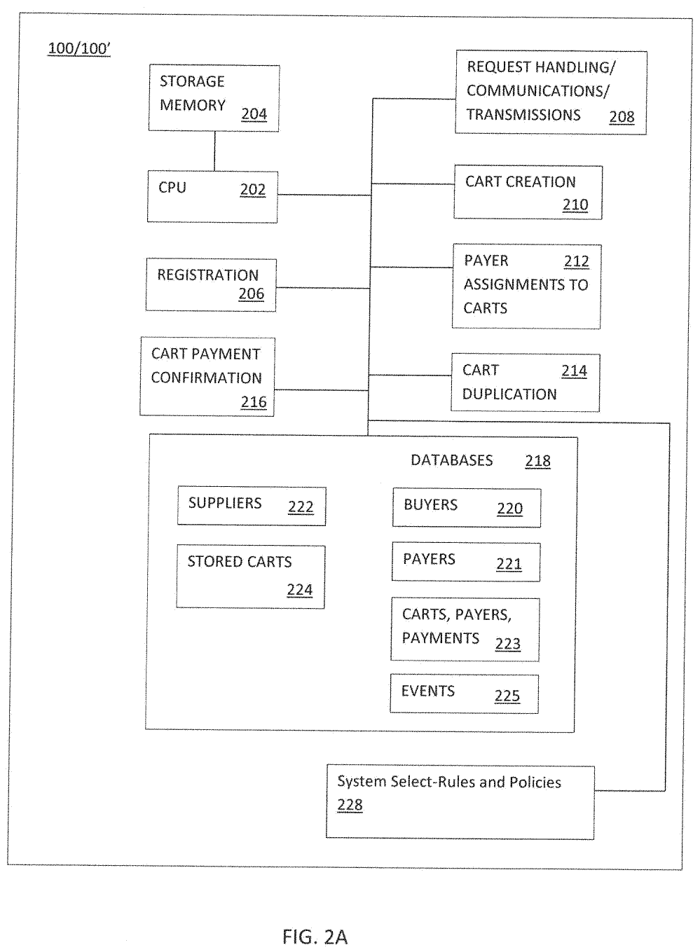

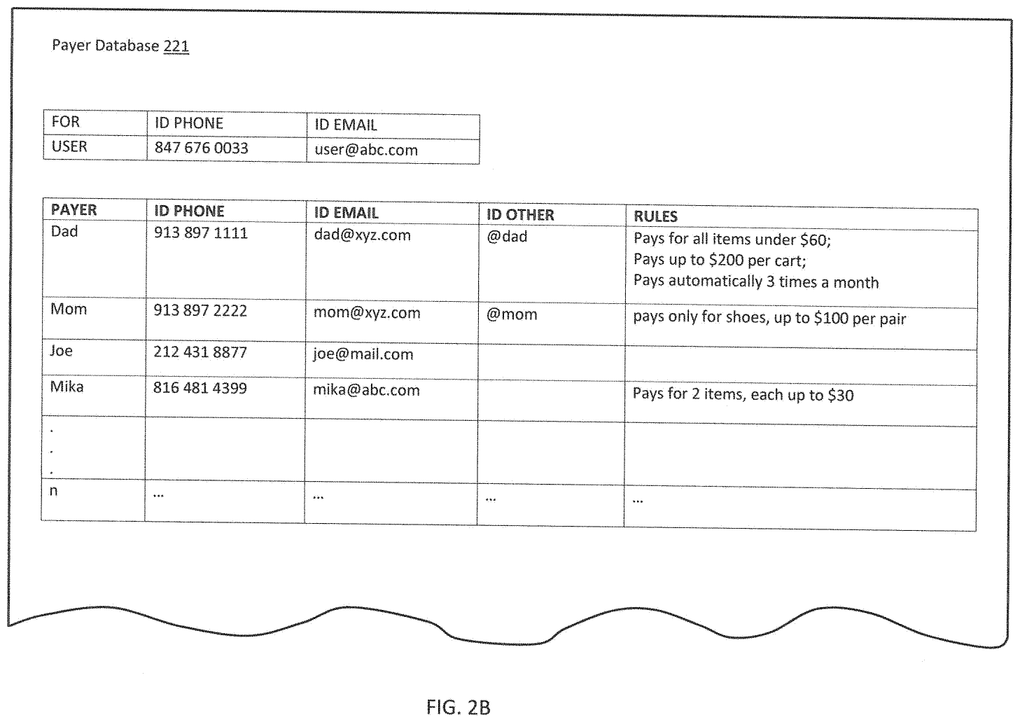

Attention is now directed to FIG. 2A, which shows the architecture of the system 100′, for example, in the home server 100. This architecture of the system 100′, as shown, for example, in the home server 100, includes a central processing unit (CPU) 202 formed of one or more processors. The CPU 202 is electronically connected to storage/memory 204, a registration and administration module 206, a request handling/communications/transmissions module 206, a cart creation module 210, and payer assignments to carts module 212, a cart duplication module 214, a cart payment confirmation module 216, databases 218, and a System Select module 228 While components 204, 206, 208, 210, 212, 214, 216, 218, and 228, are shown within the home server 100, any one or more of these components 204, 206, 208, 210, 212, 214, 216, 218, and 228, may be external to the home server 100, and be linked to the home server 100 from their external location.

The Central Processing Unit (CPU) 202 is formed of one or more processors, including microprocessors, for performing the home server 100 functions and operations detailed herein, including controlling the components 204, 206, 208, 210, 212, 214, 216, 218, and 228, and executing the instructions provided and/or obtained therefrom. The Central Processing Unit (CPU) 202 processors are, for example, conventional processors, such as those used in servers, computers, and other computerized devices, including data processors, for performing the home server 100 and system 100′ functions and operations detailed herein. For example, the processors may include x86 Processors from AMD and Intel, Xenon® and Pentium® processors from Intel, as well as any combinations thereof.

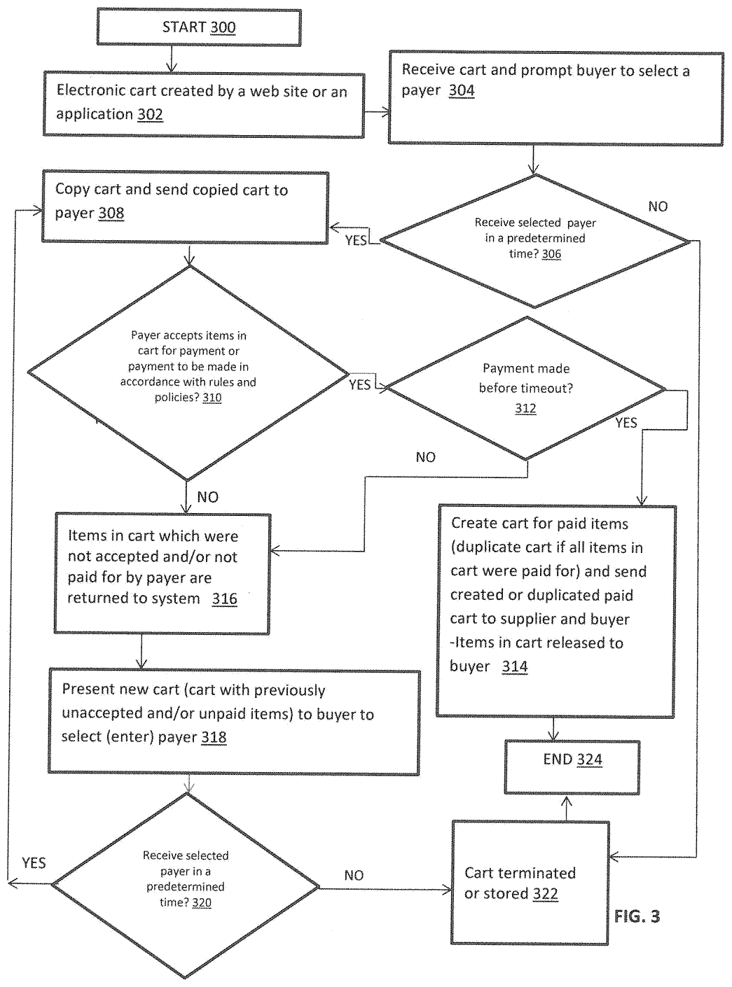

The storage/memory 204 is associated with the CPU 202 is any conventional storage media. The storage/memory 204 also includes machine executable instructions associated with the operation of the CPU 202 and the components 204, 206, 208, 210, 212, 214, 216, 218, and 228, along with the processes and subprocesses shown in FIGS. 3-5, detailed herein. The storage/memory 204 also, for example, stores rules and policies for the system 100′ and the home server 100. The processors of the CPU 202 and the storage/memory 204, although shown as a single component for representative purposes, may be multiple components, and may be outside of the home server 100 and/or the system 100′, and linked to the network 50.

The registration/administration module 206 handles registration of all users (buyers/shoppers), payers and suppliers who use, or otherwise associate with, the system 100′. This module 206 also handles administration of the system 100′, the normal day to day operations.

The request handling/communications/transmissions module 208 handles requests entering the system from users (buyers/shoppers) 109, suppliers 110a-110n and payers 115a-115n, as well as transmissions of electronic carts and associated communications from users (buyers/shoppers) 109, suppliers 110a-110n and payers 115a-115n.

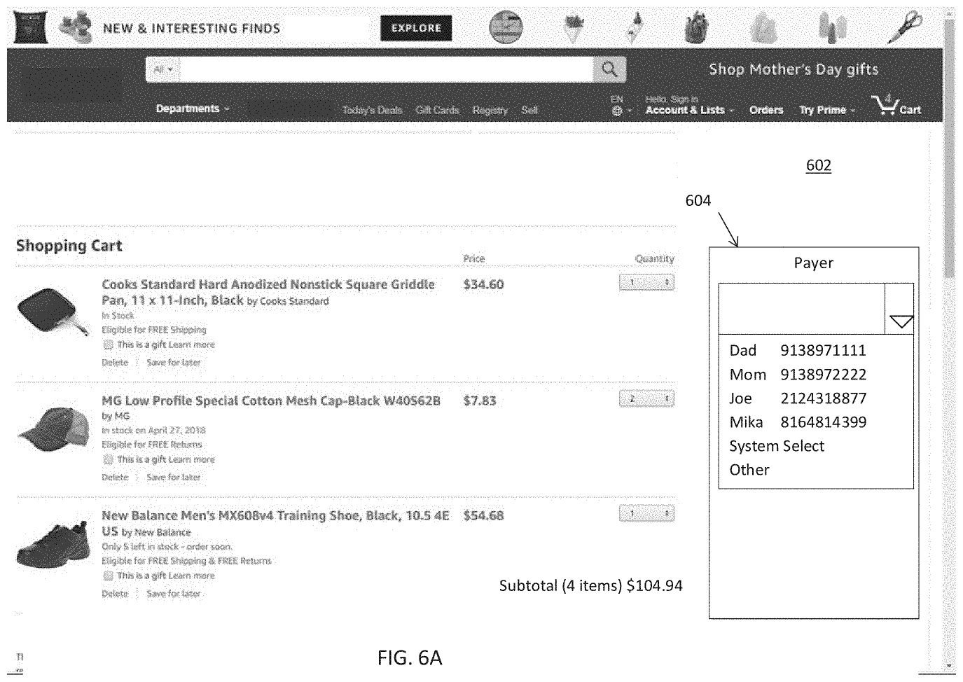

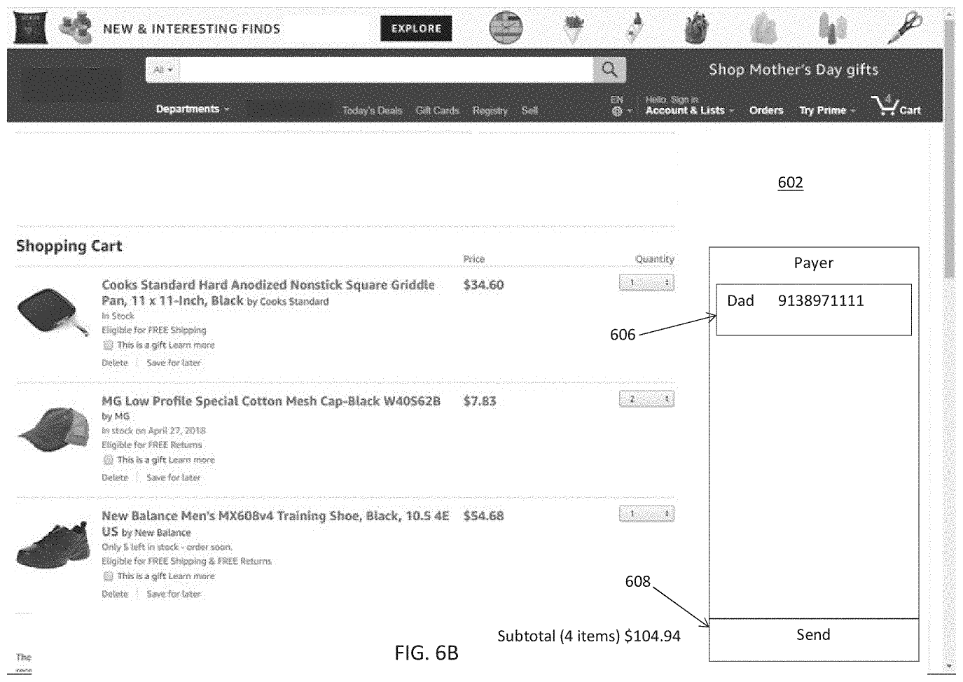

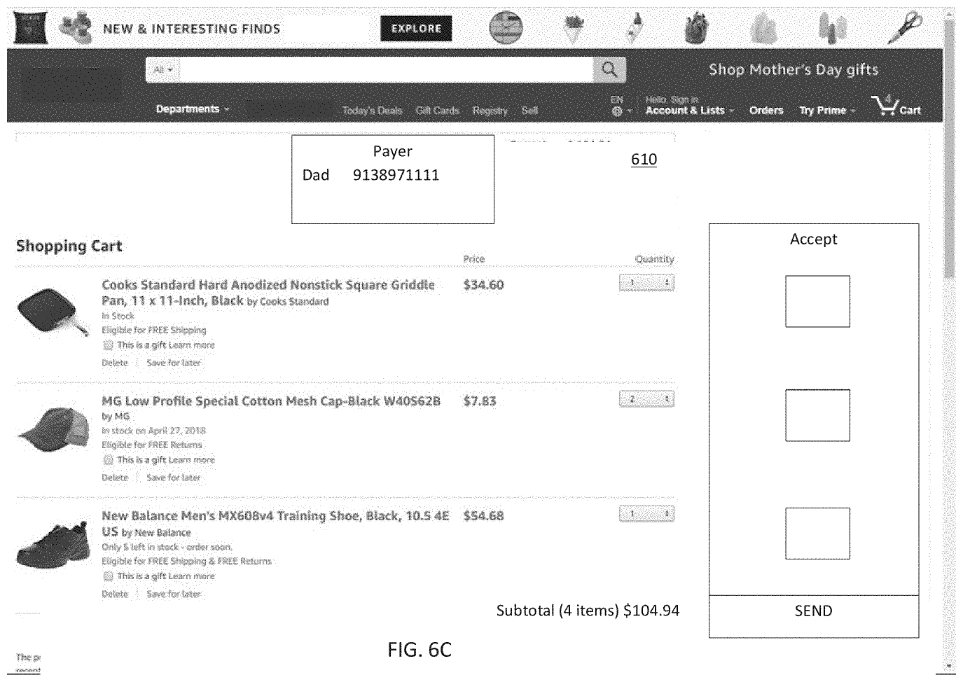

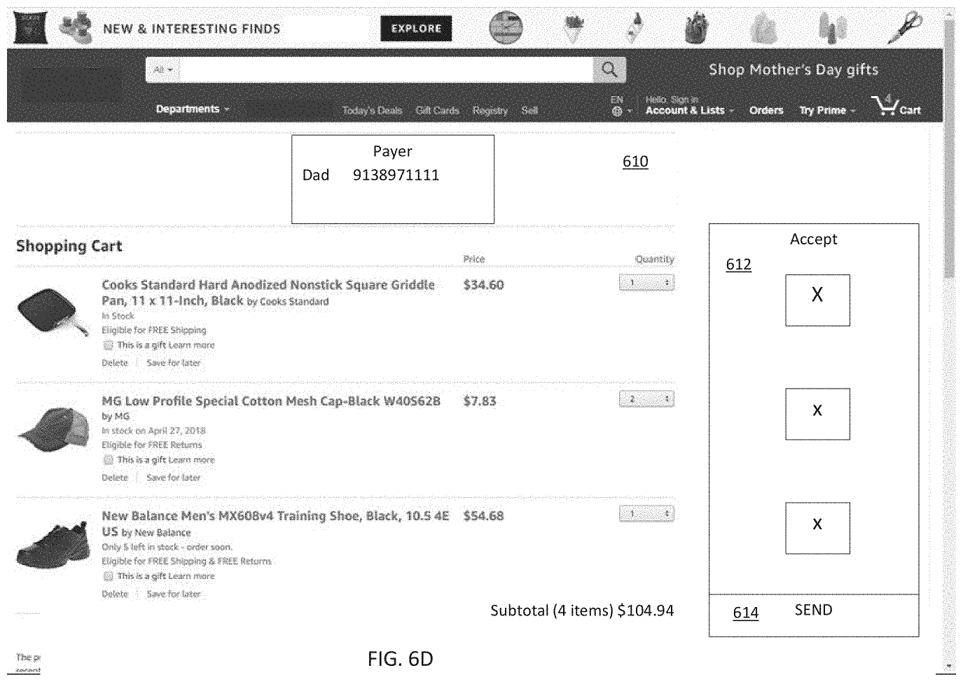

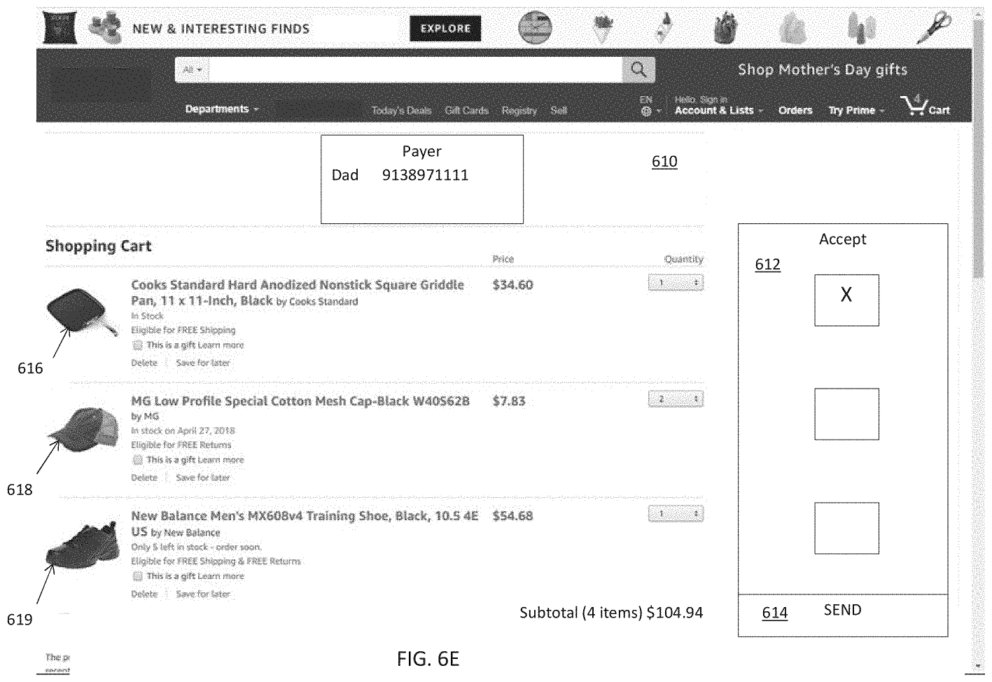

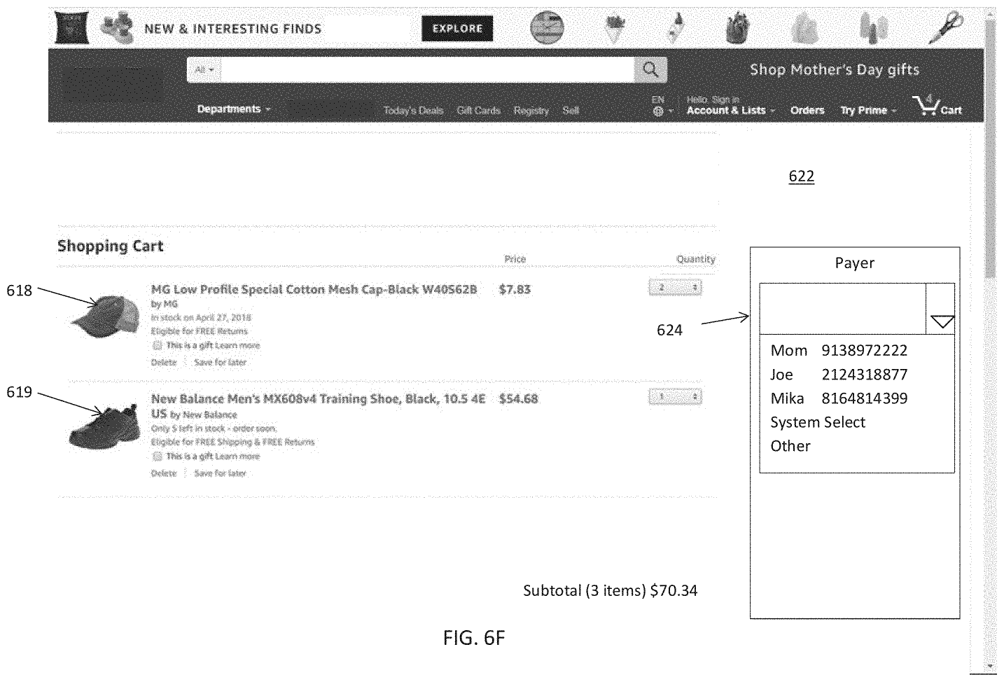

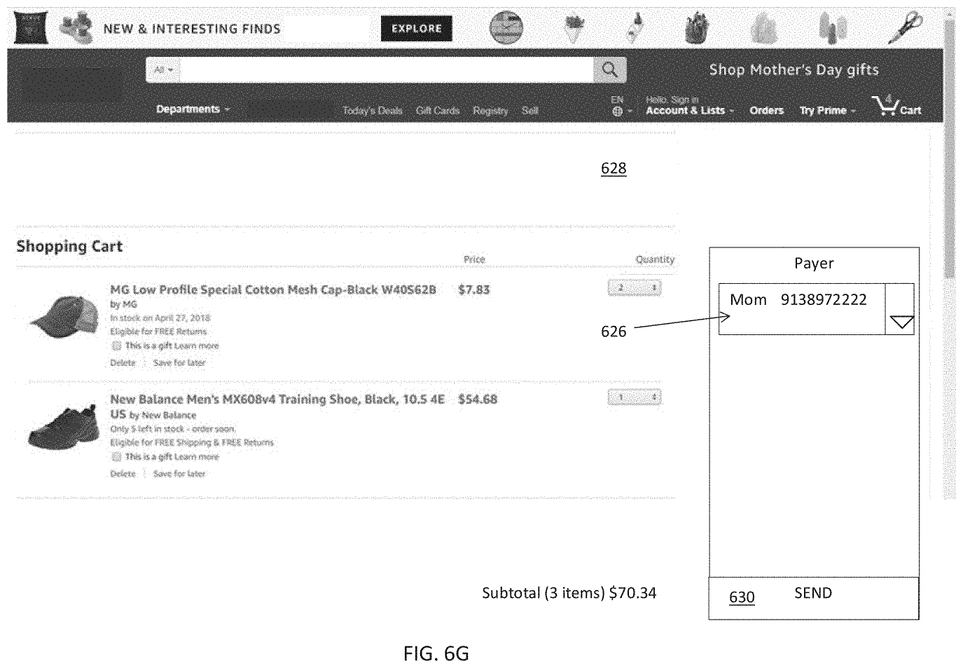

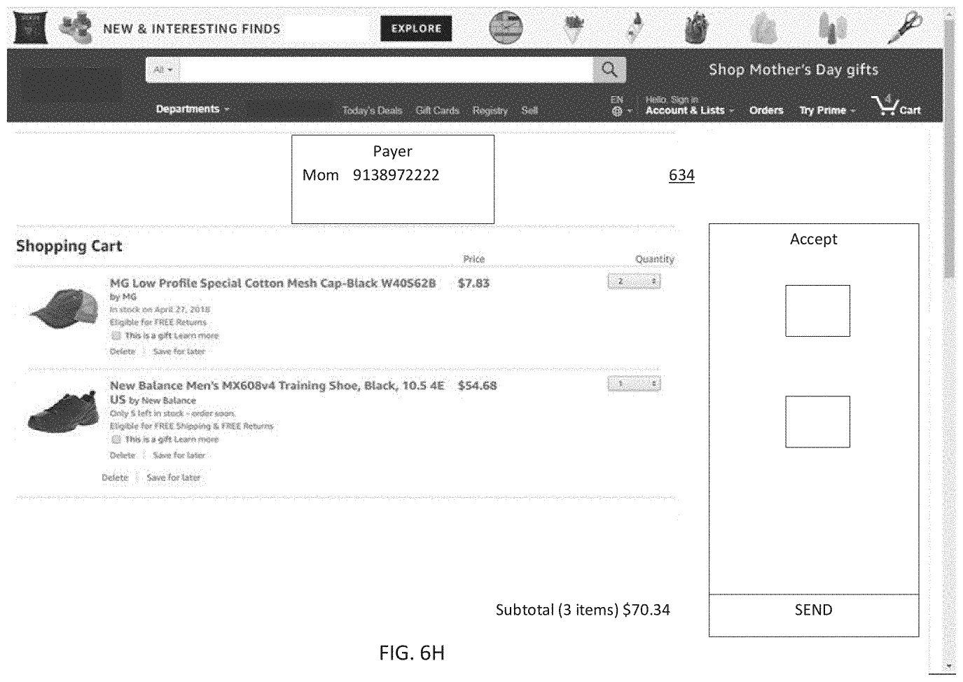

The cart creation module 210 creates electronic data objects, for example, electronic carts, which are used by the system 100′ as detailed herein. The module 210 takes all items selected by a shopper/buyer, whose associated computer is electronically connected to the system 100′, returned (non-selected for payment) and/or unpaid items in a previous electronic cart, to create a new or subsequent electronic cart. The electronic carts are configured to accept and allow for the removal of items placed into the cart, the items having been selected by the user (buyer/shopper) 109, via his mobile computer, e.g., smart phone 108. While the items are placed/removed into/out of the cart by electronic selection by the user 109, items can also be placed in electronic carts, for example, by Quick Response (QR), Radio Frequency (RF), Photographic (imaging/image processing), barcode scanning, and near field communications (NFC), and for example, removed from the cart by touching, contacting, swiping or “clicking” on the device display screen where indicated, by the user 109 (the aforementioned functionalities are typically on the smart phone 108). The cart creation module also provides the electronic cart with a list of payers, for example, as a menu 604 (FIG. 6A), one of the payers (including having the system 100′ select the payer), to be selected by the user 109, when electronically presented with the electronic cart, for example, on the display screen of the computer 108. The presentation of the menu for selecting a payer appearing on the screen display of the computer 108, with the listed items, also serves as a prompt to the user (buyer/shopper) 109 to select a payer. In the case where the user selects “System Select” to select the payer, this task is passed to the payer assignments module 212.

The payer assignments module 212 performs two main functions. It checks the payer database 221 for user-selected payers, or the resultant payer (other user-designated payer or system-selected payer), to see that they are registered with the system 100′. Additionally, when the user (buyer/shopper) 109 has selected that the system 100′ select the payer, e.g., clicking, contacting or swiping “System Select” in the menu 604 (FIG. 6A), this is a request for the system to select the payer, and accordingly, the module 212 selects a payer by either applying rules and policies, via the System Select-Rules and Policies Module 228, as detailed below. As shown in the menu 604, Dad, Mom, Joe, Mika, are previously registered with the system 100′ as payers for the user (buyer/shopper) 109 identified by the email: user@abc.com and telephone number 847-676-0033, and listed in the payer database 221, as shown in FIG. 2B, and detailed below.

The cart duplication module 214 functions to duplicate carts to be sent to payers and/or suppliers depending on the circumstances. The duplicated cart is, for example, a cart created by the cart creation module 210. The duplicated cart, for transmission (sending) to the computer of the selected payer 115a-115n, is configured to map to the supplier computer 110a-110n, for the supplier(s) of the items in the duplicated cart, and to the system 100′ of the home server 100. Accordingly, the duplicated cart at the selected payer computer 115a-115n maps to the supplier computer 110a-110n, for the supplier(s) of the items in the duplicated cart, and to the system 100′ of the home server 100. Through this mapping, the system 100′ received acceptance indications, that the payer has accepted to pay for items in the duplicated cart, as well as payment indications, that the supplier has been paid for the accepted items in the cart by the selected payer. Similarly, in cases where a duplicated cart may be transmitted (sent) to a supplier computer 110a-110n, this duplicated cart is configured to map to the system 100′ of the home server 100, and when necessary, to the computer 115a-115n of the selected payer. Accordingly, the duplicated cart at the supplier computer 110a-110n, maps to the system 100′ of the home server 100, and when necessary, to the computer 115a-115n of the selected payer.

The cart payment confirmation module 216 receives data, such as acceptance indications (or acceptance indicators, these terms used interchangeably herein), typically from the payer computer 115a-115n via the mapping of the cart, e.g., duplicated cart to the system 100′, as well as payment indications, also via the mapping, from the supplier computer 110a-110n. The received data also includes data indicating whether items in carts were paid for by a payer or went unpaid, for example, for a predetermined time period. This predetermined time period can be a preset time until a “timeout” occurs, and the payment was not made. This causes the unpaid items in a cart to be returned to the system so as to be placed in a new cart, or the cart simply stored (e.g., in the stored carts database 224) and/or terminated. The data associated with the cart storage and the carts themselves is stored, for example, in the events database 225. When payment indications are received in the module 216 of the system 100′, that payment for items in a cart has been made, these payment indications, for example, serve as indications and/or confirmations, that the paid for items in the carts are released to the buyers by the suppliers, and/or the buyers have access to the paid for items (paid for items are accessible to the buyers). The acceptance indicators, payment indicators and other data received by the cart payment module 216, is typically passed to the events database 225 (detailed below), for storage and analysis.

The databases 218 include databases for Users (Buyers/Shoppers) 220 (registered with the system 100′), Payers 221 (registered with the system 100′), Suppliers 222 (registered with the system 100′), carts with their items, payers, and payments 223, stored carts 224, and events 225. The events stored in the events database 225 include, for example, the cart presented to the payer and the initially presented items in the cart, the actual payer and the actual items in the cart they paid for, when the payment was made, was the payment manual or by rules and policies, and also, what items were not accepted (selected) by the payer, and accepted items which were ultimately not paid for (such as a timeout where the items were returned to the system 100′). Database 225 is used in conjunction with the System Select-Rules and Policies module 228. Other databases may also be used, depending on the system 100′.

Attention is now directed to FIG. 2B, which shows a portion of a payer database 221, for example, the registered payers associated with a user (buyer/shopper), e.g., user (buyer/shopper) 109 identified by telephone number 847-676-0033 and email: user@abc.com. The payers are listed, along with their Identifiers (IDs), and rules for each payer, should they not respond in a predetermined time (e.g., set by the administrator of the system 100′) with manual selections of items in carts, which they are paying for. For example, Payer “Dad” is identified by telephone number 913-897-1111, email: Dad@xyz.com, and Twitter® handle: @dad. Dad has three rules as payer for user 109. These rules are that he will pay for items in a cart, each item up to $60, and the cart can be up to $200. The final rule is that as a payer for user 109, he will only pay for three carts each month.

The System Select-Rules and Policies module 228 selects a payer in response to receiving a request to do so, when a user 109 selects the menu option “System Select” as shown for example in FIG. 6A (on the menu 604). The module 228 selects, for example, the optimum payer by applying rules and policies based on the received cart and its items, for example, based on data from the events database 225.

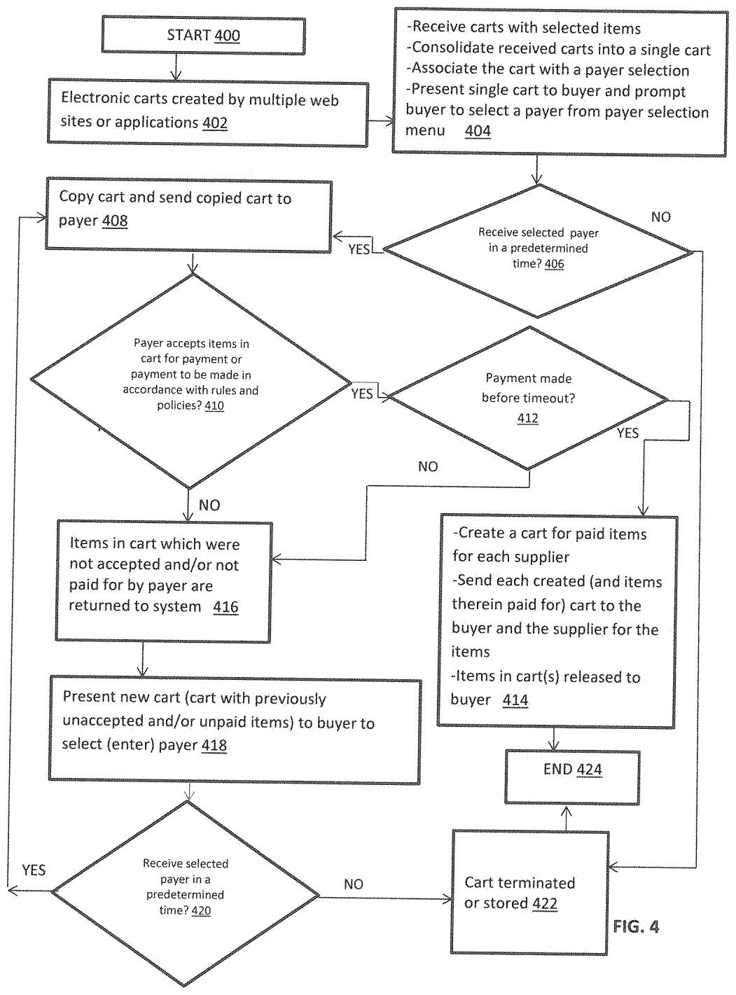

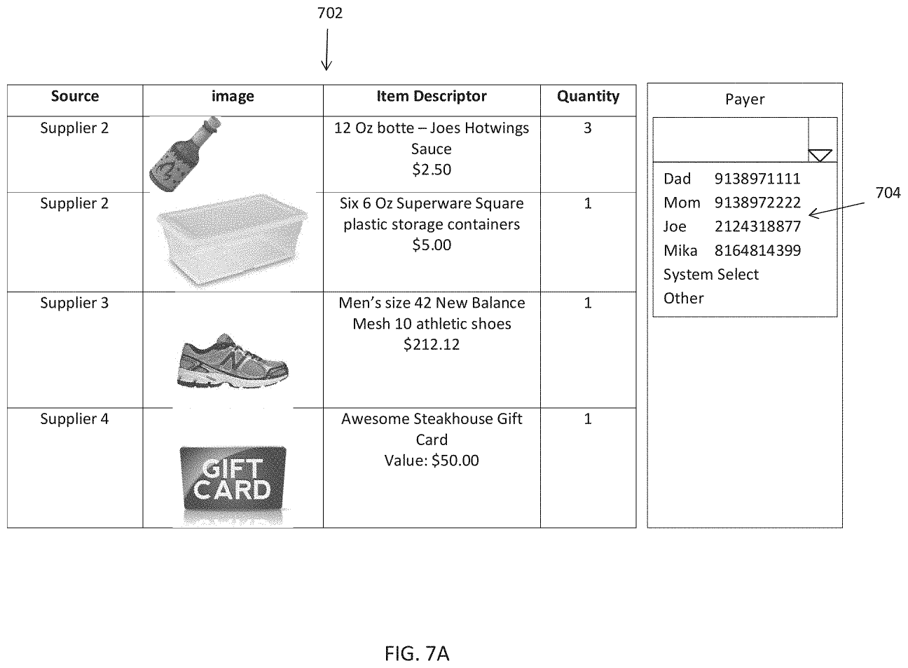

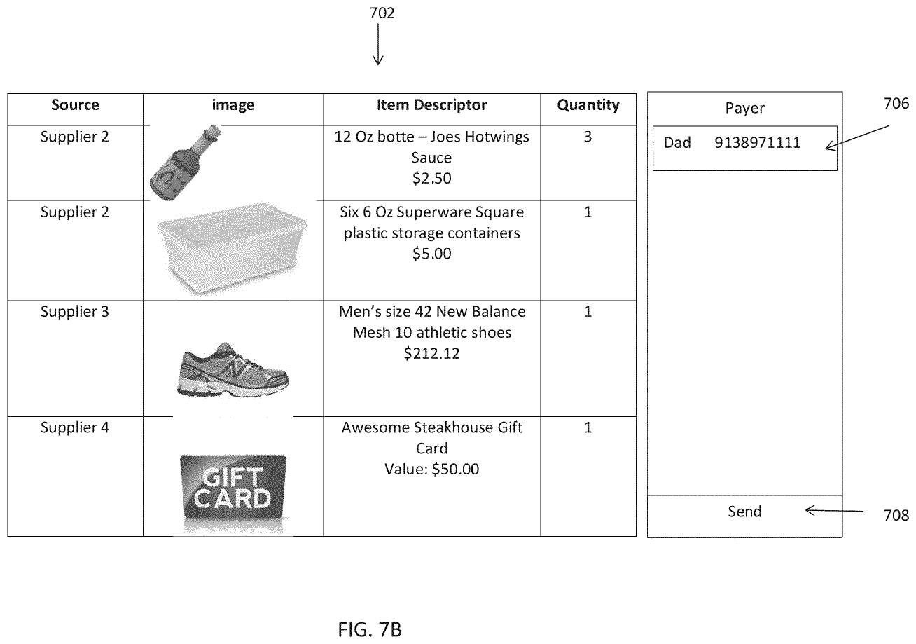

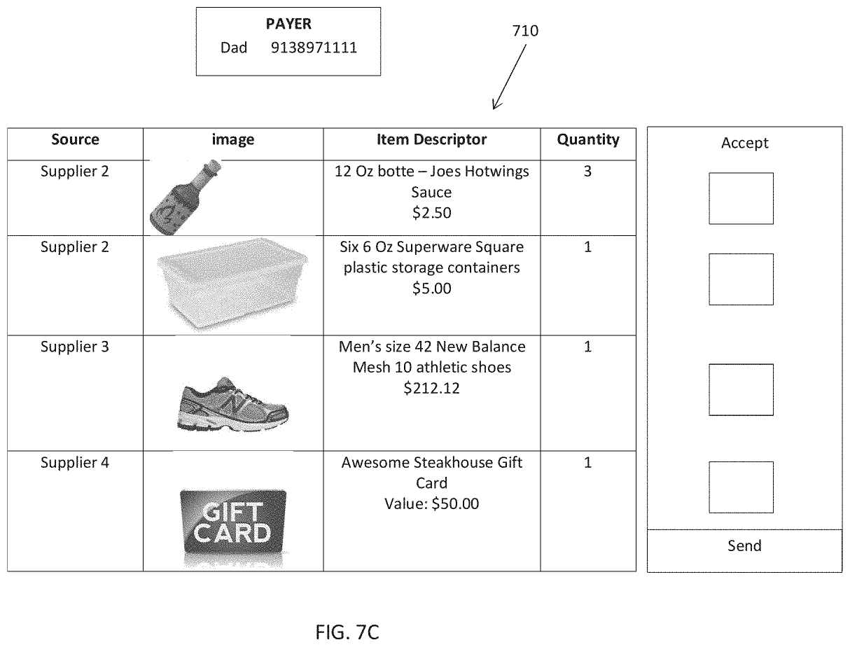

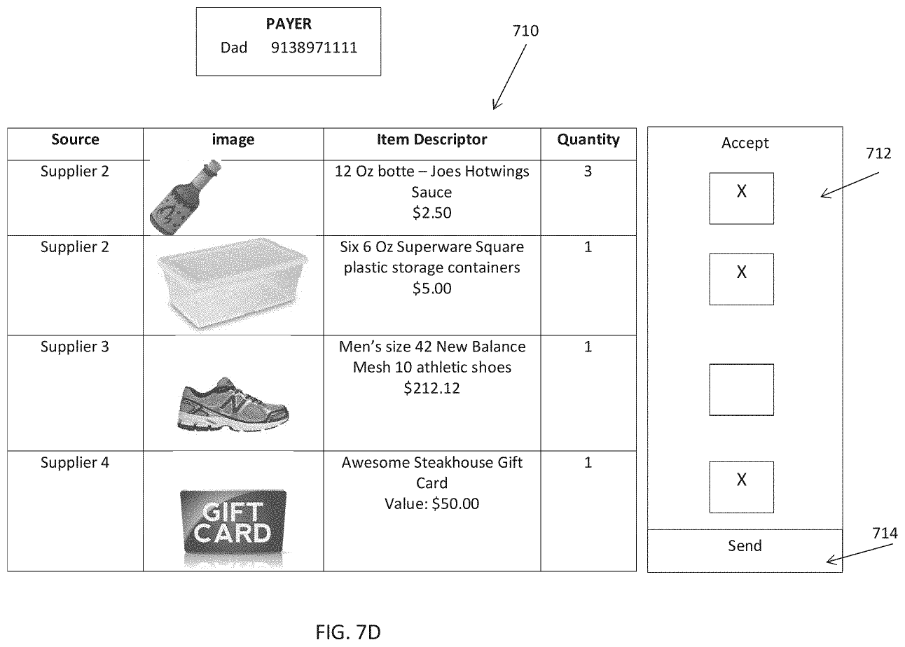

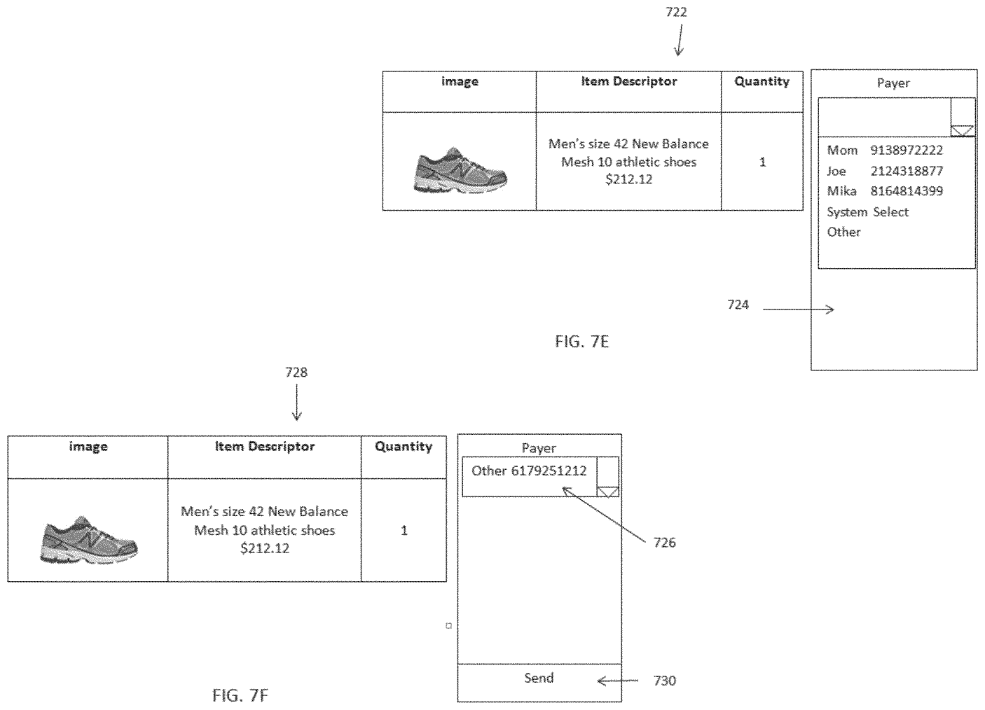

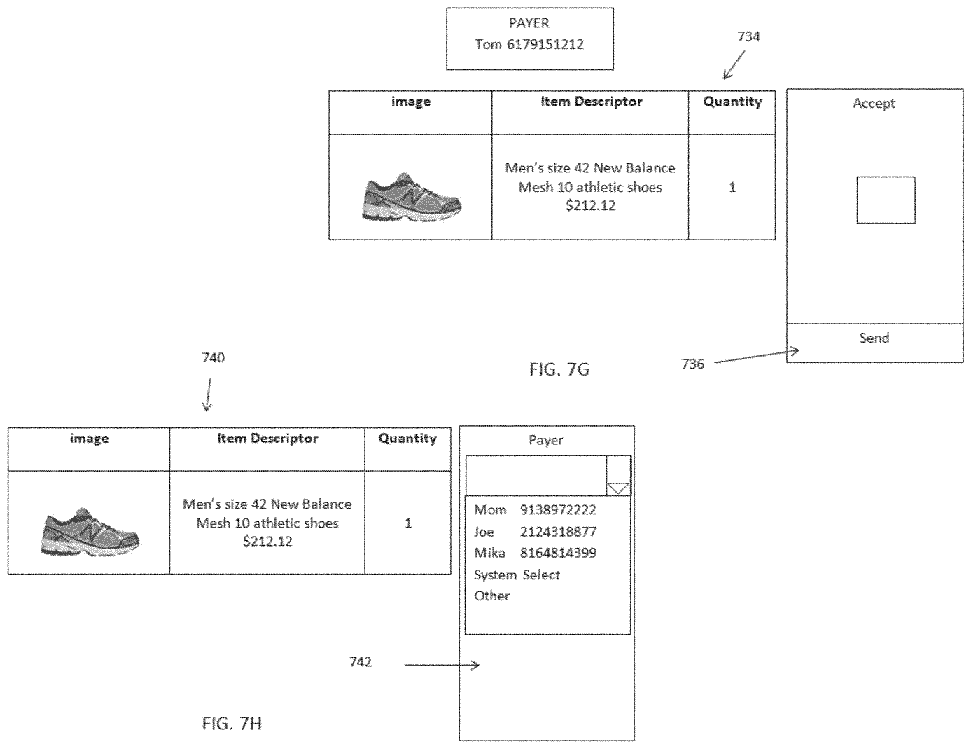

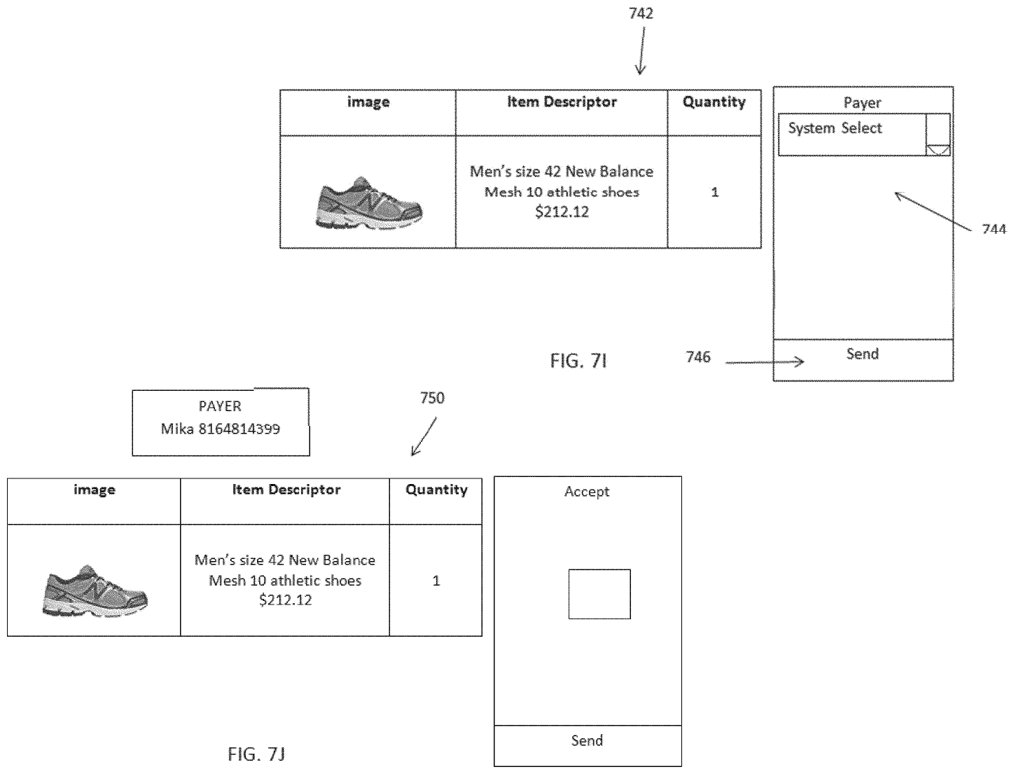

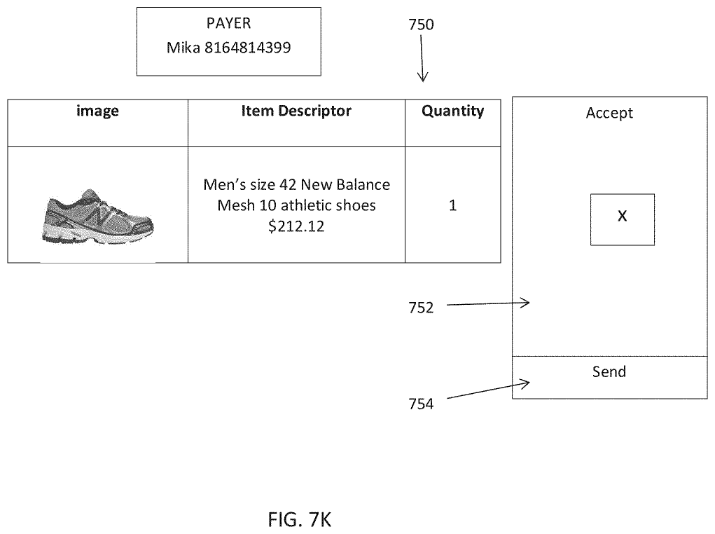

Attention is now directed to FIGS. 3-5, which show flow diagrams detailing computer-implemented processes in accordance with embodiments of the disclosed subject matter. Reference is also made to elements shown in FIGS. 1, 2A, and 2B. The process and subprocesses of FIGS. 3-5 are computerized processes performed by the system 100′, in some cases with the application 102a deployed on the user computers 108, as well as that of supplier 2, 3 and 4 110b-110n. The aforementioned processes and sub-processes can be, for example, performed manually, automatically, or a combination thereof, and, for example, in real time. Reference is also made to the diagrams and screen shots of FIGS. 6A-6H, which appear on the screen display, of the computer of the user 109 (mobile computer, e.g., smartphone 108), supplier 110a-110n and payer 115a-115n, when describing the processes of FIG. 3, as detailed below. Reference is also made to the diagrams and screen shots of FIGS. 7A-7K, which appear on the screen display, of the computer of the user 109 (mobile computer, e.g., smartphone 108), supplier 110a-110n and payer 115a-115n, when describing the processes of FIG. 4, as detailed below.

Prior to the START blocks 300, 400, 500, of the processes detailed in FIG. 3-5, the application (APP) 102a may be installed on the user computer 108, supplier computers 110b-110n, and payers 115a-115n.

Returning to FIG. 3, after the START 300, the process moves to block 302, where an electronic data object, i.e., an electronic cart, for holding user (buyer/shopper) selected items, e.g., products and services, is created by a web site or an application (e.g., APP 102a). A payer is selected for the cart, and the cart is presented to the selected payer for payment. Once payment is confirmed or otherwise verified, for example, by receiving a payment indication or payment indicator, these terms used interchangeably herein, for example from the computer of each supplier associated with the now paid items, the paid items are released to the user (buyer/shopper).

The process moves to block 304, where the cart, or data representative thereof, is received by the system 100′, with, for example, the cart graphically presented to the user computer 108 as a screen display 602 (e.g., a web page) with a payer selection list, for example, a menu of payer options 604, as shown in FIG. 6A. The display 602 of FIG. 6A is a cart created by a web site, and presents, for example, on the supplier's (e.g., Supplier 1 110a) web site as part of the “cart” web page. The payers, as listed by name on the menu 604, are registered payers in the system 100′, for example in the payer database 221. In this screen display 602, the cart includes four items for purchase (1 Griddle Pan, 2 caps and 1 shoes). The menu 604 prompts the user 109 to enter a payer for the cart, and once a payer is selected, i.e., “Dad” associated with telephone number 913-897-1111, is entered into the menu box 606 and the user 109 activates the “Send” button 608, as shown in FIG. 6B, such that a selection for Dad to be the payer has been made to the system 100′.

The process moves to block 306, where it is determined whether the system 100′ receives the selection of the payer in a predetermined time. If no, the process moves to block 322, where the cart is either stored, e.g., in the database 224 or terminated, and then the process moves to block 324, where it ends. If yes, at block 306, the process moves to block 308, where the cart is copied, and sent (transmitted) over the network 50 to the designated payer, for example, Dad (represented by the computer 115a of Payer 1). The cart displayed to Dad is represented by the screen display 610 of the screen diagram of FIG. 6C.

The process moves to block 310, where the payer may accept the items in the cart for payment, or payment is to be made in accordance with rules and policies in the system 100′, for the particular payer, in the payer database 221. For example, referring FIG. 6D, payer Dad has accepted to pay for all of the items, as indicated by the “X” in the acceptance box 612 of the screen display 610. Once Dad activates the “Send” button 614, the process moves to block 312 (where an acceptance indication is transmitted from the payer computer 115a of Dad to the system 100′ and/or to the supplier(s)). Should Dad not accept all of the items, either manually, as shown in FIG. 6E, or as per rules and policies, the process moves to block 312 for the accepted items, i.e., the “Griddle Pan” 616, and to block 316 for the non-accepted items, i.e., the caps 618 and the shoes 619.

At block 312, for the accepted items, it is determined whether a payment has been made before a timeout, a predetermined time when payment is no longer accepted by the system 100′. If yes, the process moves to block 314, where a cart is created, if only some items of the initial cart (the cart initially presented the payer) were accepted and paid for, or the cart is duplicated, if all items in the initial cart were accepted and paid for, with the created or duplicated, and now paid cart sent to the supplier 110a and/or the buyer 109, represented by his computer 108. The now paid for items, as confirmed by the module 216 (having received a payment indication from the supplier computer of the supplier for the paid item), are released and made accessible to the buyer 109, e.g., electronically, for electronic transmission, or for delivery to a physical location associated with the buyer 109, or for pick-up by the buyer 109 or his designated representative. The process moves to block 324, where it ends, as the paid carts no longer circulate in the system 100′, but may be stored, for example, in one or more of the databases 223, 224, 225. If no at block 312, the accepted items not have been paid before the timeout, and these items are returned to the system 100′, at block 316.

At block 316, the non-accepted and/or returned (for non-payment) items are returned to the system 100′, to the cart creation module 210, at block 316.

The process moves from block 316 to block 318, where the system 100′, with the non-accepted and or returned (for non-payment) items, for example, presents these items in a new cart to the buyer and the buyer is prompted to select a payer from the menu. For example, assuming that the “Griddle Pan” was accepted for payment at block 310, was timely paid, at block 312, and released to the buyer at block 314, the new cart, shown in the screen display 622 of FIG. 6F includes the caps 618 and the shoes 619, and a payer selection box 624, as presented to the buyer. The payer selection box 624 has been changed, to no longer include Dad, as Dad has already acted on certain items in the cart.

For example, the processes of blocks 310, 312 and 316 may be contemporaneous in time. Accordingly, items returned to the system 100′ from blocks 310 and 312, at block 316, may be combined and presented as a single new cart at block 318, or as individual carts, at block 318, for example, depending on the time the items arrive to the system 100′ upon their being returned to the system 100′. The process then moves to from block 318 to block 320, and proceeds as described below for each cart.

The process moves from block 318 to block 320, where it is determined whether the system 100′ receives a payer selection from the user (shopper/buyer) 109, within a predetermined time. If yes, the user (shopper/buyer) 109 has entered the selected payer, e.g., “Mom”, associated with telephone number 913-897-2222, into the payer box 626 of the screen display 628 of FIG. 6G, and activated the “Send” button 630, sending the cart (as displayed in the screen display 628) back to the system 100′. The process moves to block 308, where the cart (of screen display 628) is copied, by module 214, and sent to the computer of Mom, e.g., Payer 2 115b. This copied cart, as displayed to Mom on her computer 115b, is shown as the screen display 634 of FIG. 6H. The process resumes (repeats) from block 308, as detailed above.

Returning to block 320, should a payer selection not be received within the predetermined time period, the process moves to block 322, where the cart is either stored, e.g., in the database 224 or terminated. The process then moves to block 324, where it ends.

Turning to FIG. 4, after the START 400, the process moves to block 402, where electronic data objects, i.e., electronic carts, for holding user (buyer/shopper) selected items, e.g., products and services, are created by web sites and/or applications (e.g. APP 102a), such that a payer is selected for the cart. The cart is presented the cart is presented to the selected payer for payment. Once payment is confirmed or otherwise verified, for example, by receiving a payment indication, for example from the computer of each supplier associated with the now paid items, the paid items are released to the user (buyer/shopper).

The process moves to block 404, where the carts, or data representative thereof, are received by the system 100′, with the carts consolidated into a single cart. The single cart is graphically presented to the user computer 108 as a screen display 702, and the now single cart is associated with a payer selection list, for example, a menu of payer options (menu) 704, as shown in FIG. 7A. The payers, as listed by name in the menu 704, are registered payers in the system 100′, for example in the payer database 221. In this screen display 702, the cart includes six items for purchase (3 Hot Sauces, 1 Storage Containers, 1 Shoes and 1 Gift Card). The menu 704 prompts the user 109 to enter a payer for the cart, and once a payer is selected, “Dad” associated with telephone number 913-897-1111, entered into the menu box 706 and the user 109 activates the “Send” button 708, as shown in FIG. 7B.

The process moves to block 406, where it is determined whether the system 100′ receives the selection of the payer in a predetermined time. If no, the process moves to block 422, where the cart is either stored, e.g., in the database 224, or terminated, and then the process moves to block 324, where it ends. If yes, at block 406, the process moves to block 408, where the cart is copied, and sent (transmitted) over the network 50 to the designated payer, for example, Dad (represented by the computer 115a of Payer 1). The cart displayed to Dad is represented by the screen display 710 of the screen diagram of FIG. 7C.

The process moves to block 410, where the payer may accept the items in the cart for payment or payment is to be made in accordance with rules and policies in the system 100′, for the particular payer, in the payer database 221. For example, referring FIG. 7D, payer Dad was contacted but did not accept to pay for the items manually (by entering the acceptance as input into his computer 108, which is transmitted to the system 100′ and/or the supplier). Since rules and policies were in place for Dad, in the Payers Database 221 (FIGS. 2A and 2B), they were applied to the cart and accordingly, Dad has accepted to pay all of the items, as indicated by the “X” in the acceptance box 712, but not the shoes, of the screen display 710. Under the rules and policies activation, the “Send” button 714 activates, and the process moves to block 412. As Dad did not accept all of the items, i.e., the shoes, as shown in FIG. 7D, as per rules and policies, the process moves to block 412 for the accepted items, i.e., the hot sauce, storage containers, and the gift card (where an acceptance indication is transmitted from the system 100′ to the supplier(s)), and to block 416 for the non-accepted items, i.e., the shoes.

At block 412, for the accepted items, it is determined whether a payment has been made before a timeout, a predetermined time when payment is no longer accepted by the system 100′. If yes, the process moves to block 414. At block 414, individual carts are created for each supplier, each cart including representations of the paid items from that supplier. For example, from the cart of FIG. 7D, one cart is created for Supplier 2, and includes the hot sauce and the storage containers, while another cart is created for Supplier 4 which includes the gift card. One cart for Supplier 2 The now paid individual carts are each sent to the individual supplier (e.g., Supplier 2 110b and Supplier 4 110d) and/or the buyer. The now paid for items, as confirmed by the module 216 (having received payment indications for each paid item from the requisite supplier, e.g., supplier computer), are released and made accessible to the buyer (e.g., from the supplier of the paid for item). The process moves to block 424, where it ends, as the paid carts no longer circulate in the system 100′, but may be stored, for example, in one or more of the databases 223, 224, 225.

Returning to block 410, unaccepted items, e.g., the Shoes (from the screen display 710 of FIG. 7D), are returned to the system 100′, to the cart creation module 210, at block 416. Similarly, at block 412, should the accepted items not have been paid before the timeout, these items are also returned to the system 100′, at block 416.

The process moves from block 416 to block 418. At block 418, the system 100′, with the non-accepted and or returned (for non-payment) items, for example, presents these items in a new cart to the buyer and the buyer is prompted to select a payer from the menu. For example, assuming that the hot sauce, storage containers and gift card, were accepted for payment at block 410, and were timely paid, at block 412, and released to the buyer at block 414, the new cart, shown in the screen display 722 of FIG. 7E includes the shoes, and a payer selection box 724, as presented to the buyer. The payer selection box 624 has been changed, to no longer include Dad, as Dad has already acted on certain items in the cart.

For example, the processes of blocks 410, 412 and 416 may be contemporaneous in time. Accordingly, items returned to the system 100′ from blocks 410 and 412, at block 416, may be combined and presented as a single new cart at block 418, or as individual carts, at block 418, for example, depending on the time the items arrive to the system 100′ upon their being returned to the system 100′. The process then moves to from block 418 to block 420, and proceeds as described below for each cart.

The process moves from block 418 to block 420, where it is determined whether the system 100′ receives a payer selection from the user (shopper/buyer) 109, within a predetermined time. If yes, the user (shopper/buyer) 109 has entered the selected payer, e.g., “Other”, associated with “Tom” at telephone number 617-925-1212, into the payer box 726 of the screen display 728 of FIG. 7F, and activated the “Send” button 730, sending the cart (as displayed in the screen display 628) back to the system 100′. The system 100′, through the module 208, sends an electronic communication, e.g., text, email, social network communication, telephone call, to contact Tom, so that he can become registered with the system 100, through the registration module 206, so that he Tom at 617-925-1212 is a payer in the payer database 221. Here, for example, Tom was contacted, he registered with the system 100′, and became a payer in the database 221 (and is listed in the payer database 221, associated with the user 109, accordingly).

The process moves from block 420 to block 408, where the cart (of screen display 728) is copied, by module 214, and sent to the computer of Tom, e.g. Payer n 115n. This copied cart displays as screen display 734 of FIG. 7G on Tom's computer 115n.

Returning to block 420, should a payer selection not be received within the predetermined time period, the process moves to block 422, where the cart is either stored, e.g., in the database 224 or terminated. The process then moves to block 424, where it ends.

Returning to block 408 and the screen display 734 of FIG. 7G, Tom has not accepted to pay for the shoes, as per block 410. Rather, Tom has left the “Accept” box blank and activated the “Send” button 736, moving the process to block 416, where the shoes are returned to the system 100′. The process then moves to block 418, where a new cart is presented to the buyer to select (enter) a payer. This is shown, for example by the cart of the screen display 740 of FIG. 7H, where the user 109 is presented with the cart including a menu box 742. The process moves to block 420, where a payer is selected, for example, the payer has been selected as “System Select”, in box 744 and sent to the system 100′ by activation of the “Send” button 746, of the screen display 740, of FIG. 7I.

The process moves to block 408, where the cart is copied and sent to the system selected payer Mika. The cart appears as the screen display 750 of FIG. 7J. Mika is the system selected payer, as selected by the system select module 228, applying rules and policies. For example, the rule or policy may be “who was the last payer to pay for items similar to the items in the cart”, here, for example, shoes. Checking the events database 225, for this buyer 109, the last payer for shoes was Mika. Accordingly, Mika is selected by the system 100′ as the payer for this cart, based on the application of Rules and Policies by the Rules and Policies Module 228.

The process moves to 410, where Mika accepts to pay for the shoes (“X” in the accept box 752), and activating the “Send” button 754 of the screen display 750 of FIG. 7K. Here, when the process moves to block 412, Mika has made a timely payment for the shoes. Accordingly, from block 412, the process moves to block 414, as detailed above (where the user 109 has access to the shoes (via his mobile computer 108), as paid for by Mika), and then to block 424, where the process ends.

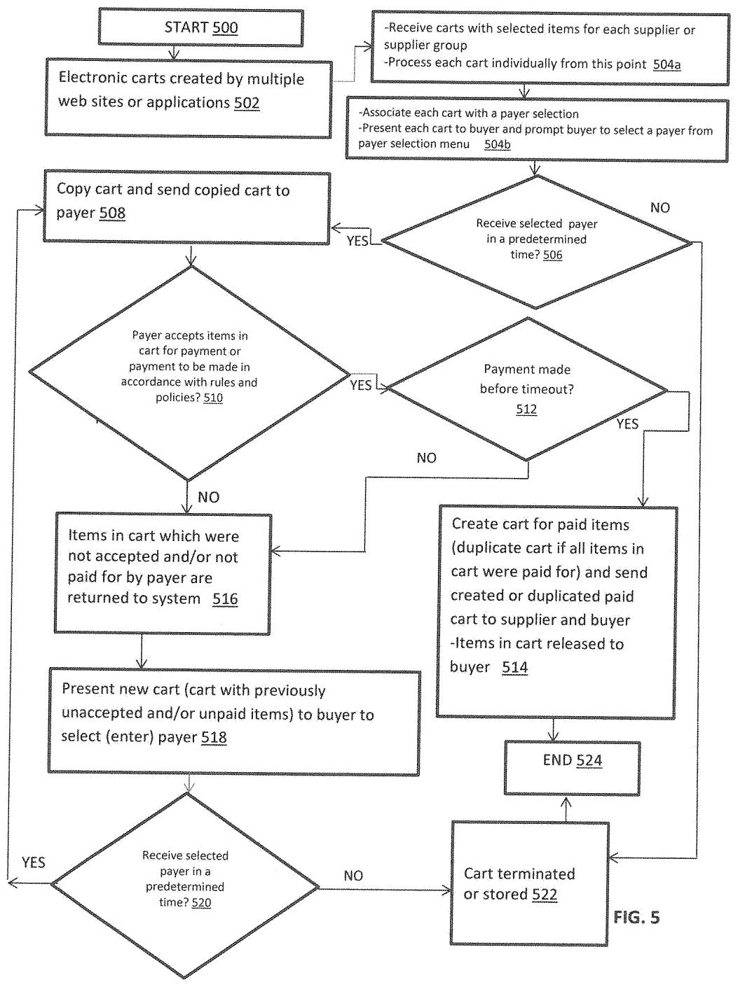

Turning now to FIG. 5, after the START 500, the process moves to block 502, where electronic data objects, i.e., electronic carts, for holding user (buyer/shopper) selected items, e.g., products and services, is created by web sites or an applications (e.g., APP 102a). A payer is selected for each cart, the carts which are presented to the selected payer for payment, and once payment is confirmed or otherwise verified, the paid items are released and made accessible to the user (buyer/shopper).

The process moves to block 504a, where each cart, or data representative thereof, is received by the system 100′, each cart corresponding to a supplier of items or supplier group. Each cart is now processed individually going forward. Accordingly, multiple carts can be processed by the system contemporaneously, including simultaneously.

Moving to block 504b, from block 504a, each cart is associated with a payer selection, e.g., graphically on a display screen, with a payer selection menu, as discussed above. Each cart, with the payer selection menu is, for example, graphically, presented (by display) to the user computer 108, and the user is prompted to select a payer from the menu. The payers, as listed by name, are registered payers in the system 100′, for example in the payer database 221.

The process moves to block 506, where it is determined whether the system 100′ receives the selection of the payer in a predetermined time. If no, the process moves to block 522, where the cart is either stored, e.g., in the database 224, or terminated, and then the process moves to block 524, where it ends. If yes, at block 506, the process moves to block 508, where the cart is copied, and sent (transmitted) over the network 50 to the designated payer.

From block 508, the process moves to block 510, where the payer may accept the items in the cart for payment or payment is to be made in accordance with rules and policies in the system 100′, for the particular payer, in the payer database 221. For accepted items by the payer, the process moves to block 512. For non-accepted items by the payer, the process moves to block 516.

At block 512, for the accepted items (e.g., for which one or more acceptance indications have been sent from the payer computer to the system 100′, e.g., module 216), it is determined whether a payment has been made before a timeout, a predetermined time when payment is no longer accepted by the system 100′. If yes, the process moves to block 514, where a cart is created, if only some items of the initial cart (the cart initially presented the payer) were accepted and paid for, or the cart is duplicated, if all items in the initial cart were accepted and paid for, with the created or duplicated, and now paid cart sent to the supplier and/or the buyer. The now paid for items, as confirmed by the module 216 (having received a payment indication from the supplier computer of the supplier for the paid item), are released and made accessible to the buyer (from the supplier of the paid for item). The process moves to block 524, where it ends, as the paid carts no longer circulate in the system 100′, but may be stored, for example, in one or more of the databases 223, 224, 225.

Returning to block 510, unaccepted items are returned to the system 100′, to the cart creation module 210, at block 516. Similarly, at block 512, should the accepted items not have been paid before the timeout, these items are also returned to the system 100′, at block 516. The process moves from block 516 to block 518, where the system 100′, with the non-accepted and/or returned (for non-payment) items, for example, presents these items in a new cart to the buyer and the buyer is prompted to select a payer from the menu.

The process moves from block 518 to block 520, where it is determined whether the system 100′ receives a payer selection from the user (shopper/buyer) 109, within a predetermined time. If yes, the user (shopper/buyer) 109 has entered the selected payer, into the cart (e.g., payer selection menu associated with the cart), and the process returns to block 508, from where it resumes, as discussed above.

Returning to block 520, should a payer selection not be received within the predetermined time period, the process moves to block 522, where the cart is either stored, e.g., in the database 224 or terminated. The process then moves to block 524, where it ends.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A computerized method for making payments for items selected by a buyer, comprising:
(a) receiving, by a main computer over a communications network, 1) an electronic data object including a listing of one or more items, each of the one or more items of the electronic data object selected by a buyer associated with a buyer computer, from a supplier associated with a supplier computer; and, 2) a selection of a payer for the items of the electronic data object, from the buyer computer;
(b) the main computer responding to receipt of the electronic data object and the selection of a payer by transmitting a copy of the electronic data object to a computer associated with the payer, the copy of the electronic data object mapped to the computer of each supplier for each of the items and to the main computer; and,
(c) the main computer receiving a payment indication, over the communications network, from each of the supplier computers for the items which the payer has paid for, the payment indication additionally being an indicator that all items that were paid for are released to the buyer.

2. The method of claim 1, additionally comprising:
(d) for the items that were not paid for, creating a subsequent electronic data object including the items that were not paid for, and presenting the subsequent data object to the buyer computer to receive a selection for a payer for the electronic data object.

3. The method of claim 2, additionally comprising:
(e) the main computer responding to receipt of the subsequent electronic data object and the selection of a payer by transmitting a copy of the subsequent electronic data object to a computer associated with the payer, the copy of the electronic data object mapped to the computer of each supplier for each of the items and to the main computer,
(f) the main computer receiving a payment indication, over the communications network, from each of the supplier computers for the items which the payer has paid for, the payment indication additionally being an indicator that all items that were paid for are released to the buyer.

4. The method of claim 3, wherein the receiving the selection of a payer includes receiving a selection of at least one of: a specific payer, or a request for the main computer to select the payer.

5. (canceled)

6. The method of claim 4, wherein the specific payer includes a payer from a database of payers associated with the buyer, or a payer not from a database of payers associated with the buyer.

7. The method of claim 4, wherein the request for the main computer to select a payer is based on rules and policies.

8. The method of claim 1, wherein prior to step (a), the electronic data object including a listing of one or more items is presented to the buyer via the buyer computer, and the buyer, via the buyer computer, is prompted to select a payer for the items of the electronic data object.

9. The method of claim 1, additionally comprising, the main computer receiving an acceptance indication for the items of the electronic data object which the payer will pay for, transmitted to the main computer from the payer computer.

10. The method of claim 1, additionally comprising, the main computer receiving an acceptance indication for the items of the electronic data object which the payer will pay for in accordance with rules and policies.

11. The method of claim 9, wherein, if said acceptance indication is not received for an item and/or the payer has failed to pay for an item within a predetermined time, the first computer takes at least one action including:
creating a subsequent electronic data object including the unaccepted item and/or the not paid for item, and sending the subsequent electronic data object to the buyer computer for selection of a payer;
terminating the electronic data object; or,
storing the electronic data object.

12. The method of claim 10, wherein if the at least one action includes creating a subsequent electronic data object including the unaccepted item and/or the not paid for item, and sending the subsequent electronic data object to the buyer computer for selection of a payer, the main computer:
(a) receives from the buyer computer, over the communications network, 1) the subsequent electronic data object including a listing of the unaccepted and/or not paid for item; and, 2) a selection of a payer for the items of the electronic data object;
(b) responds to receipt of the electronic data object and the selection of the payer by transmitting a copy of the electronic data object to the computer associated with the payer, the copy of the electronic data object mapped to the computer of each supplier for each of the items and to the main computer; and,
(c) receives a payment indication over the communications network, from each of the supplier computers for the items which the payer has paid for, such that all items that were paid for are released to the buyer.

13. The method of claim 11, wherein
the electronic data object includes at least one electronic shopping cart,
the subsequent electronic data object includes at least one electronic shopping cart.

14. (canceled)

15. The method of claim 1, wherein the electronic data object is from a web site or an application.

16. A method for paying for items purchased by a buyer comprising:
receiving, by a payment system associated with a main computer, a first electronic data object including items associated from at least one supplier and a selection of a payer for the items of the first electronic data object, from a computer associated with a buyer of the items of the first electronic data object;
sending, by the payment system associated with the main computer, a second electronic data object, based on the first electronic data object, to a computer associated with the selected payer for the first electronic data object, the second electronic data object mapped to the computer associated with the at least one supplier and the main computer;
receiving acceptance indications whether each item of the second electronic data object that was accepted by the payer for payment, and, for items that were accepted by the payer for payment and paid for, receiving a payment indication;
for items of the second electronic data object that were either not accepted for payment by the payer and/or not paid for by the payer, the payment system of the main computer creating a third electronic data object for the non accepted items and/or the unpaid items for presentation to the buyer via the computer associated with the buyer; and,
for items of the second electronic data object that were accepted and paid for by the payer, for which the payment indication was received by the payment system of the main computer, the payment indication additionally indicating that the paid for items of the second electronic data object are accessible to the buyer.

17. The method of claim 16, wherein the payment system of the main computer receives the acceptance indications and the payment indications.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. A computer system for paying for items purchased by a buyer, comprising:
a storage medium for storing computer components; and,
at least one processor for executing the computer components comprising:
a first computer component for receiving a first electronic data object including items associated from at least one supplier, and a selection of a payer for the items of the first electronic data object, from a computer associated with a buyer of the items of the first electronic data object;
a second computer component for sending a second electronic data object, based on the first electronic data object, to a computer associated with the selected payer for the first electronic data object, the second electronic data object mapped to the computer associated with the at least one supplier and the main computer;
a third computer component for receiving acceptance indications whether each item of the second electronic data object that was accepted by the payer for payment, and, for items that were accepted by the payer for payment and paid for, receiving a payment indication; and
a fourth computer component for:
creating a third electronic data object for the non accepted items and/or the unpaid items of the second electronic data object, for presentation to the buyer via the computer associated with the buyer; and,
receiving at least one payment indication for items of the second electronic data object that were accepted and paid for by the payer, the at least one payment indication additionally indicating that the paid for items of the second electronic data object are accessible to the buyer.

30. The system of claim 29, wherein the second electronic data object is a copy of the first electronic data object.

31. The system of claim 30, wherein the third electronic data object is created with items from the second electronic data object.

32. (canceled)

33. (canceled)

34. (canceled)

35. The system of claims method of claim 30, wherein the first electronic data object, the second electronic data object, and the third electronic data object are electronic shopping carts.

36. A computer usable non-transitory storage medium having a computer program embodied thereon for causing a suitable programmed system to pay for items purchased by a buyer, by performing the following steps when such program is executed on the system, the steps comprising:
receiving a first electronic data object including items associated from at least one supplier and a selection of a payer for the items of the first electronic data object, from a computer associated with a buyer of the items of the first electronic data object;
sending a second electronic data object, based on the first electronic data object, to a computer associated with the selected payer for the first electronic data object, the second electronic data object mapped to the computer associated with the at least one supplier and the main computer;
receiving acceptance indications whether each item of the second electronic data object that was accepted by the payer for payment, and, for items that were accepted by the payer for payment and paid for, receiving a payment indication;
for items of the second electronic data object that were either not accepted for payment by the payer and/or not paid for by the payer, creating a third electronic data object for the non accepted items and/or the unpaid items for presentation to the buyer via the computer associated with the buyer; and,
for items of the second electronic data object that were accepted and paid for by the payer, for which the payment indication was received, the payment indication additionally indicating that the paid for items of the second electronic data object are accessible to the buyer.

37. (canceled)

38. (canceled)

39. (canceled)

40. (canceled)

41. (canceled)

42. (canceled)

43. (canceled)

44. (canceled)

45. (canceled)

46. (canceled)

47. (canceled)
